(19) United States
(12) Patent Application Publication
(10) Pub. No.: US 2008/0126962 A1
(43) Pub. Date: May 29, 2008

(54) Online closet management and organizer system and method

(76) Inventor: Rosalind Cook, Oakland, CA (US)

Correspondence Address: FIDEL D. NWAMU, 761 HADDON PLACE, OAKLAND, CA, 94610, US

(21) Appl. No.: 11/605,788

(22) Filed: Nov. 29, 2006

(51) Int. Cl. G06F 3/048; G06F 17/30; H04L 9/32; G06F 15/16

(52) U.S. Cl. 715/764; 707/100; 726/4; 707/E17.044

(57) ABSTRACT

An online system and method for managing and organizing closets (i.e., “walk-in” closets and the like). The system and method uses captured images of clothing items and accessories stored in the closet for managing and organizing the closet. Images of the clothing items and accessories are first captured using a digital camera. The captured images are transferred to a PC (Personal Computer) or the like for uploading to an online server. After receipt, these captured images are then classified based on attributes or characteristics of the clothing items and accessories (or their corresponding images). An example of such attributes is the “Designer” of the clothing item and accessory. After classification, the captured images are stored for future retrieval by a user. The captured images can also be grouped into outfits representing combinations of the clothing items and accessories.

### BACKGROUND OF THE INVENTION

The present invention relates generally to closets and computer systems and methods and more specifically to a system and method for online management and organization of clothing items and accessories.

Closets for storing clothing items and accessories have become quite indispensable. They can be utilized for hanging dresses, suits, etc. and for storing shoes and seasonal clothing such as scarves and gloves. It is thus not uncommon for a single residence to have various relatively large-sized closets. In fact, some walk-in closets are so large that celebrities have been known to store hundreds of clothing items and 50 or more pairs of shoes in such closets.

Many closets whether “reach-ins” or “walk-ins” are sectional. They typically have a clothing hanging section and a shelving section, which has one or more shelves. The user utilizes hangers on bars in the clothing hanging section for hanging clothing items. Clothing items can also be folded for placement on the shelves. As additional clothing items are acquired, they are hung adjacent to each other. At some point, not only does the closet become overly crowded, it is such that only the edges or sleeves of the clothing items remain visible.

In getting dressed, the user often employs the visible clothing item edges for determining what to wear. Once selected, the clothing item is removed from the closet for examination. If satisfied, the user can then wear the clothing item. Otherwise, it is returned to the closet for hanging. This process continues until the user finds a satisfactory outfit. The user can waste considerable amounts of time and effort removing and returning clothing items until the right attire is found.

As mentioned above, as more clothing items are acquired, the closet becomes overly crowded. At some point, even the previously visible clothing item edges are no longer visible. For example, a pair of pants adjacent to a large evening gown in a crowded closet quickly becomes obscure. In fact, it is not uncommon for the user to discover unworn clothing items (with store tags) purchased awhile back. These clothing items remained unworn in the crowded closet because they were inaccessible.

In addition, components for an outfit within a closet are usually segregated. For example, a dress might be in the hanging section while the corresponding hat is located on another shelf with the matching shoes in a separate shoe bin. To get dressed, the user must first determine whether this outfit is suitable and whether they match by placing each component, i.e., the dress, hat and shoes on a flat surface (e.g., a bed). If the components match and result in a visually pleasant combination, the user wears the outfit. Otherwise, the entire process must be repeated for a different outfit. This process can become frustrating particularly when the user is strapped for time, such as when the user is late for work.

Statistics also show that users wear 10% to 20% of what they have 80% to 90% of the time. While this may not be entirely accurate, it is clear that many users fail to wear majority of their clothing items and accessories majority of the time.

There is a need to address one or more of the foregoing disadvantages of conventional closets systems and methods and the present invention meets this need.

### BRIEF SUMMARY OF THE INVENTION

Various aspects of an online closet organizer and system can be found in exemplary embodiments of the present invention. According to a first embodiment, a system for using images to manage clothing items and accessories in a closet is disclosed. This closet might be a “reach-in,” “walk-in” or other type closets employed by a user for storing clothing items and accessories. The system includes an imaging device (e.g., digital camera) capable of capturing images of clothing items and accessories in the closet.

This system further includes a computing device that receives the captured images from the imaging device and uploads the captured images to an online server. Thus, the present invention, unlike conventional systems, uses these captured images to efficiently track clothing items and accessories irrespective of whether a closet is crowded or whether clothing item edges remain visible. It also provides for storing as many images without the physical dimensional restrictions of the closet.

After the captured images are uploaded, and upon user request, the online server categorizes the captured images according to attributes of the clothing items and accessories. Attributes refer to the type of clothing item and accessory, its color, season, category, designer and/or description, for example. After the captured images are categorized and upon user request, the online server stores the captured images for future retrieval based on the aforementioned attributes. Unlike typical closets, users can employ attributes to quickly narrow their choices for clothing items and accessories to wear thus saving considerable time and effort during the dress up process.

According to one aspect, upon user request the online server groups two or more of the captured images into an outfit. Such grouping might be based on one whether the clothing items and accessories (or corresponding images) match and/or whether they are complementary. It can also be based on whether they form a visually pleasant combination. In this manner, the present invention allows predefined outfits to be stored in advance of the dress up process. The conventional process of determining an outfit to wear during the dress up is eliminated thus saving users considerable amounts of time and effort.

According to a second embodiment of the present invention, a method for organizing clothing items and accessories in a closet is disclosed. Among others, this method includes capturing images of the clothing items and accessories in the closet and uploading the capture images to a remote location (e.g., online server). Here, any commonly known type of digital camera or the like may be employed for capturing the images.

Upon uploading, the captured images are categorized by using one or more characteristics of the clothing items and accessories. The captured images are then stored for future retrieval based on the characteristics, which may include the type of clothing item and accessory, its color, season, category, designer and/or description. In a further aspect, the method also includes grouping two or more captured images into an outfit based on whether the captured images are matching. Here, note that the captured images are captured for uploading by the user. Alternatively, the distributor or seller of clothing items and accessories may capture the images for uploading.

According to a third embodiment of the present invention, a method for managing a user's personal closet (e.g., “walk-in” closet) is described. This method includes receiving captured images of clothing items and accessories in the closet. Preferably, an online server is used for receiving the captured images. After they are received, these captured images are then classified according to attributes of the clothing items and accessories. Note that the attributes can be selected from any one or more of type, color, season, category, designer and description. These same attributes may also be utilized for future searches. After classification, the method then involves storing the captured images for future retrieval by a user. Again, preferably, the online server is used for classifying and storing the captured images.

In one aspect, the method comprises grouping two or more captured images into an outfit if the images are complementary; and storing the one or more outfits for future retrieval. The outfit can include combinations of two or more captured images of each of a hat, jacket, shirt, pants or skirt, sweater and accessories. In this manner, the present invention allows predefined outfits to be stored in advance of the dress up process. The process for matching clothing items and accessories need not be engaged in thus conserving much of users' energy and time.

In a further aspect, upon a user request for access to the captured images, the method authenticates the user, and if authentication is valid, provides user access to the captured images for searching, viewing or arranging the captured images. As noted, clothing items and accessory attributes are utilized for searching. Viewing can include displaying all outfits stored in the closet or displaying all images stored in the closet. In this, manner, all clothing and accessories in the closet remain accessible to users so that majority of their clothing items and accessories can be worn majority of the time. Users need not concern themselves about discovering unworn clothing items (with store tags) that were purchased awhile back as in conventional closet systems.

According to a fourth embodiment of the present invention, a system for organizing clothing items and accessories in a closet is disclosed. This system includes means for capturing images (e.g., a digital camera) of the clothing items and accessories in the closet. This system also includes means for uploading said captured images, an example of such means being a computing device such as a PC (personal computer). The system also includes means for categorizing (e.g. online server) said captured images by using one or more characteristics of the clothing items and accessories, and means for storing (e.g. online server database) said captured images for future retrieval by a user.

In a further aspect, the system comprises means for grouping (e.g. online server) two or more captured images into an outfit based on whether said images are matching. The system further includes means for searching (e.g. online server database) the captured images based on one or more attributes selected from type, color, season, category, designer and description.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 shows a network diagram for a closet system for organizing and managing clothing items and accessories in accordance with an exemplary embodiment of the present invention.

FIG. 2 illustrates a method for managing or organizing clothing items and accessories in accordance with an exemplary embodiment of the present invention.

FIG. 3 shows a “Welcome” page screen shot according to an exemplary embodiment of the present invention.

FIG. 3A shows an upload page screen shot according to an exemplary embodiment of the present invention.

FIG. 3B shows a screen shot of a “File Upload” dialog box in accordance with an exemplary embodiment of the present invention.

FIG. 3C shows a “Categorize Your Clozet” screen shot according to an exemplary embodiment of the present invention.

FIG. 4A shows a first “Add an Outfit” page screen shot according to an exemplary embodiment of the present invention.

FIG. 4B shows a second “Add an Outfit” page screen shot according to an exemplary embodiment of the present invention.

FIG. 4C shows an “Add a Shirt” page screen shot according to an exemplary embodiment of the present invention.

FIG. 4D shows a first “Save Your Outfit” page screen shot in accordance with an exemplary embodiment of the present invention.

FIG. 4E shows a second “Save Your Outfit” page screen shot according to an exemplary embodiment of the present invention.

FIG. 5 shows an “Outfit Gallery” page screen shot according to an exemplary embodiment of the present invention.

FIG. 6 shows a “Clozet Gallery” page screen shot according to an exemplary embodiment of the present invention.

FIG. 7A shows a first “Arrange Clozet” page screen shot according to an exemplary embodiment of the present invention.

FIG. 7B shows a second “Arrange Clozet” page screen shot in accordance with an exemplary embodiment of the present invention.

FIG. 8 shows clothing items and accessories stored in the closet of FIG. 2.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

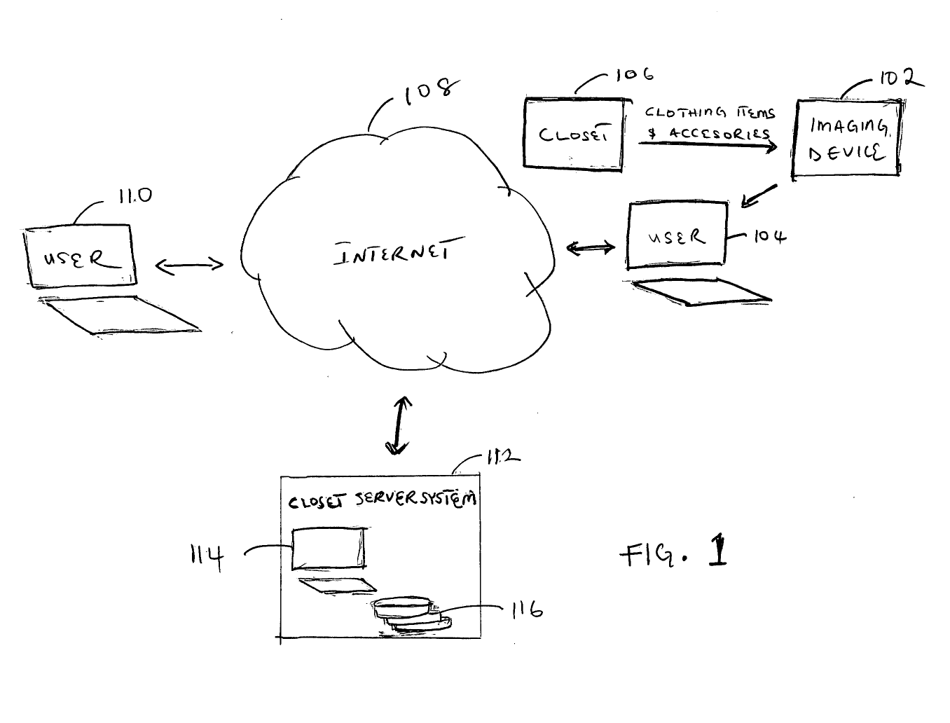

FIG. 1 is a network diagram of a closet system 100 for organizing and managing clothing items and accessories in accordance with an exemplary embodiment of the present invention.

In FIG. 1, among other components, closet system 100 comprises imaging device 102 communicably coupled to user 104 computing device. Imaging device 102 may be a digital camera for capturing images (and data) of clothing items and accessories stored in closet 106. Closet 106 might be a typical “walk-in” or “reach-in” commonly found in many homes. Captured images are transferred from imaging device 102 to user 104, which is coupled to closet server system 112 via Internet 108. Other users (e.g., user 110) are also connected to closet server system 112 via Internet 108 as well. Although not shown, Internet 108 represents any distributed network (wireless, wired, e.g., RS232) for data transmission and receipt between two points.

User 104 can access closet server system 112 to store and retrieve captured images (and data) of clothing items and accessories. Closet server system 112 in this example is accessible via its associated proprietary website www.myclozet.com. User 110 similarly has access to closet server system 112 for data and image storage and retrieval.

Although shown as a computing device in FIG. 1, user 104 may represent an individual employing said computing device for data and image access. The computing device may be a personal computer, telephone, wireless device or the like. The computer itself can be of varying types including laptop, notebook, palm-top, pen-top, etc., and may not resemble the computer of FIG. 1 as in the case where a processor is embedded into another device or appliance such as an automobile or a cellular telephone. Because of the ever-changing nature of computers and networks, the description of hardware in this specification is intended only by way of example for the purpose of illustrating the embodiment.

As noted, closet server system 112 is accessible via its associated proprietary website www.myclozet.com. This website is hosted by dedicated server 114 of closet server system 112, which also includes storage device 116. Closet server system 112 can be considered a content management system and repository for data and images. Closet server system 112 may include both relational and object XML data stores (not shown). Closet server system 112 can provide for storage, viewing, importing, organizing, modifying, exporting and querying of clothing items and accessories information.

In operation, user 104 begins by registering with closet server system 112. Preferably, this is achieved by logging onto www.myclozet.com, a proprietary website hosted by closet server system 112. Registration allows user 104 to create an account for closet 106. Once an account (and closet) is created, user 104 can begin uploading captured images of clothing items and accessories. In particular, captured images of each and every clothing item and accessory found in closet 106 are uploaded to closet server system 112 for storage. In this manner, unlike conventional systems, the present invention tracks all clothing items and accessories that can potentially become obscured in the user's crowded closet.

After or contemporaneously with uploading, user 104 directs closet server system 112 to categorize all of the uploaded images based on one or more clothing attributes. Examples of clothing attributes are “Description,” and “Designer” of a clothing item. As an example, a shirt might have the following attributes: “Description”=“Shirt Purchased at Bloomingdale's 2004 ½ Year Sale;” and “Designer”=“Versace.” By categorizing each clothing item and accessory in this manner, unlike conventional closets, the present invention can retrieve clothing items and accessories based on one or more search attributes. These attributes are of course exemplary and one of ordinary skill in the art will understand that other existing reservation systems and types within this invention's scope can be utilized.

After the images are categorized, user 104 then groups the images into outfits, which are two or more matching clothing items and accessories. Or they can be a combination of clothing items and accessories that form a visually pleasant combination. As an example, an outfit can be a combination of a blue skirt, a white shirt and a matching pair of blue shoes. These predefined outfit combinations are then saved for future retrieval. In this manner, a user need not determine visually pleasant combinations when getting dressed and can retrieve the predefined combinations to determine what outfit will be worn prior to dress up thus saving considerable time and effort during the dress up process.

In summary, an online closet management and organizer system and method is disclosed. Specifically, the system and method uses captured images to manage a user's personal closet (e.g., “walk-in” closet). Images of clothing items and accessories stored in the closet are captured using a digital camera. The captured images are transferred to a PC (Personal Computer) or the like for uploading to an online server. After receipt, these captured images are then classified based on attributes or characteristics of the clothing items and accessories (or their corresponding images). An example of such attributes is the “Designer” of the clothing item and accessory. After classification, the captured images are stored for future retrieval by a user. The captured images can also be grouped into outfits representing combinations of the clothing items and accessories.

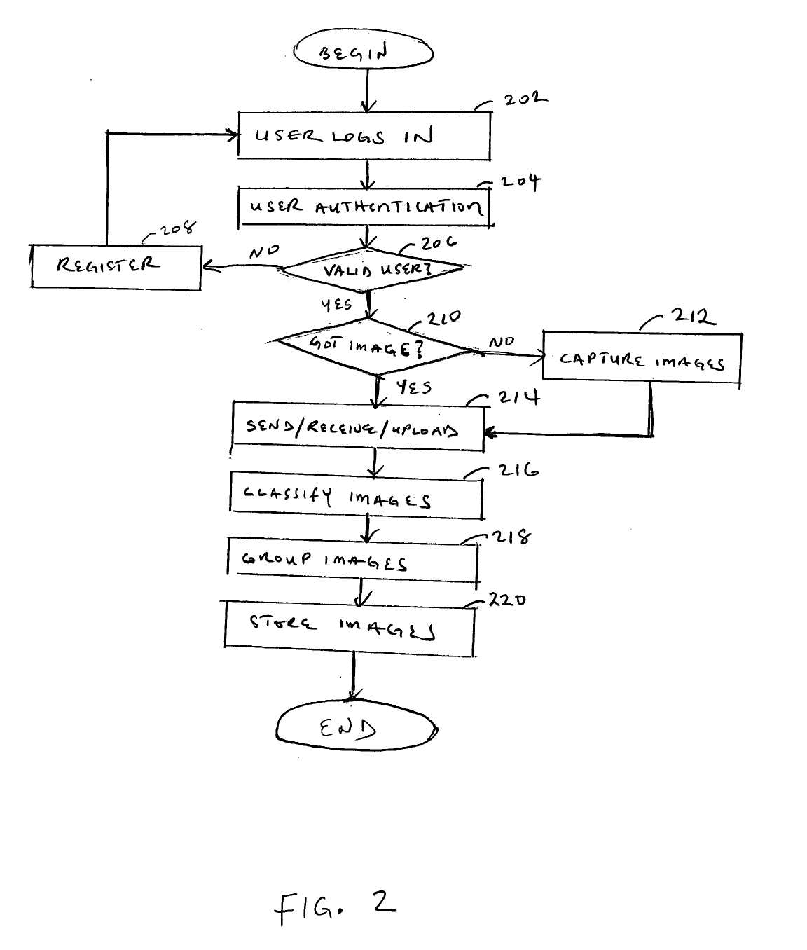

FIG. 2 illustrates a method 200 for managing or organizing clothing items and accessories in accordance with an exemplary embodiment of the present invention.

Briefly, method 200 involves initially determining whether user 104 is properly credentialed after logging onto www.myclozet.com, a proprietary website hosted by closet server system 112 (FIG. 1). If all checks out, and user 104 has previously captured images of clothing items and accessories, method 200 involves receiving (preferably by an online server) captured images of the clothing items and accessories in closet 106. After image uploading, method 200 involves categorizing or classifying the captured images according to attributes or characteristics of the clothing items and accessories. Method 200 also involves grouping two or more captured images into an outfit if the captured images are complementary and storing the outfits for future retrieval.

In more detail, at step 202 (FIG. 2), user 104 logs onto www.myclozet.com. This is a proprietary website hosted by closet server system 112 (FIG. 1).

At step 204, closet server system 112 next authenticates user 104 for proper credentials, i.e. to determine whether user 104 was properly registered.

At step (decision box) 206, if user 104 is unregistered, method 200 returns to step 208 for registration.

At step 208, specifically, user 104 registers with closet server system 112. User 104 logs onto www.myclozet.com to enter personal and user preference information into various data entry forms presented by dedicated server 114. The collected information is then used to create a new account. Closet server system 112 then assigns a uniquely identifiable username and password to the user account. This username/password can then be employed for future access to the account. After the account is created, user 104 can then return to step 202 to access the newly created account.

Once the user account is created, user 104 may grant temporary access privileges to other selected parties. These access privileges typically expire after a period designated by user 104. The selected parties can then utilize the temporary access privileges for access to closet 106. In this manner, personal stylists, personal shoppers and the like can have access to closet 106 to effectuate their clients' wishes.

Returning to decision box 206, if the user is registered, method 200 proceeds to step (decision box) 210.

At step (decision box) 210, if user 104 has previously captured images of clothing items and accessories in closet 106, the method proceeds to step 214. However, if user 104 has no captured images, method 200 proceeds to step 212 for image procurement.

At step 212, user 104 captures images of clothing items and accessories in closet 106. Specifically, user 104 employs imaging device 102 for capturing said clothing items and accessories images.

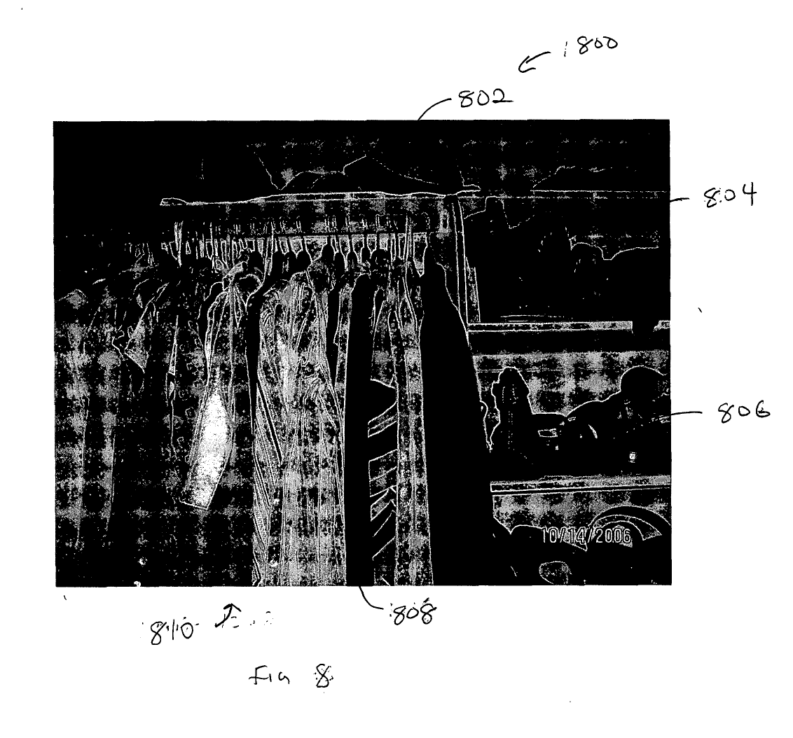

FIG. 8 shows clothing items and accessories 800 stored in closet 106 of FIG. 2.

In FIG. 8, user 104 captures images of hat 802, handbags 804, shoes 806, all of which are stored on various shelves. User 104 also captures images of shirt 808 and shirts 810 hanging in the clothing hanging. Preferably, user 104 uses a digital camera or the like for image capture. The digital camera may be any conventional digital camera device (e.g., Canon Powershot SD 500) commonly employed by consumers for image capture.

Images can be captured in any order. User 104 might choose to begin with shirts 810. Each shirt 808 is removed from closet 106 and placed on a suitable surface. A full front view image of each shirt 808 is then captured. After the shirt images are captured, images of shoes 806 are taken, followed by images of handbags 804 and hat 802. Preferably, all images are captured to maintain in the same manner. For example, images might be captured using a consistent depth and focus such that all image sizes are proportionate. This maintains visual pleasantness when the closet images are viewed online. Furthermore, images taken against plain white background are preferable. Thus, the present invention, unlike conventional systems, uses these captured images to efficiently track clothing items and accessories 800 irrespective of whether closet 106 is crowded or whether clothing item edges remain visible. It also provides for storing as many captured images without the actual physical dimensional restrictions of closet 106.

Note that the present invention refers to “clothing items and accessories” as those that are storable in a closet and are wearable, attachable to or can be held by the user. Shirt 808, hat 802 or handbag 804 is each generically considered a “clothing item and accessory.”

At step 212, images captured by imaging device 102 are transferred to user 104 computing device, and from which said images are uploaded to closet server system 112. Here, user 104 computing device and imaging device 102 are communicably coupled by a USB (Universal Serial Board) cable or the like. Alternatively, user 104 computing device can be bypassed entirely provided imaging device 102 incorporates Internet access and web browsing functionalities.

Further yet, it is contemplated that images of clothing items and accessories can be directly uploaded to closet server system 112 by the clothing seller or distributor at the time of purchase. For example, assume that a shirt is purchased at a departmental store. At check out, an RFID (Radio Frequency Identification) tag attached to the shirt automatically triggers transfer of the shirt image from the department store to closet server system 112 for inclusion in the user's online closet. Essentially, the department store partners with closet system 100 to have preexisting access to closet server system 112. In this manner, the online closet can remain updated with little or no input from user 104. One of ordinary skill in the art will understand that these are but exemplary illustrations of the present invention and other implementations are contemplated. After images of clothing items and accessories in closet 106 are captured, method 200 then proceeds to step 214.

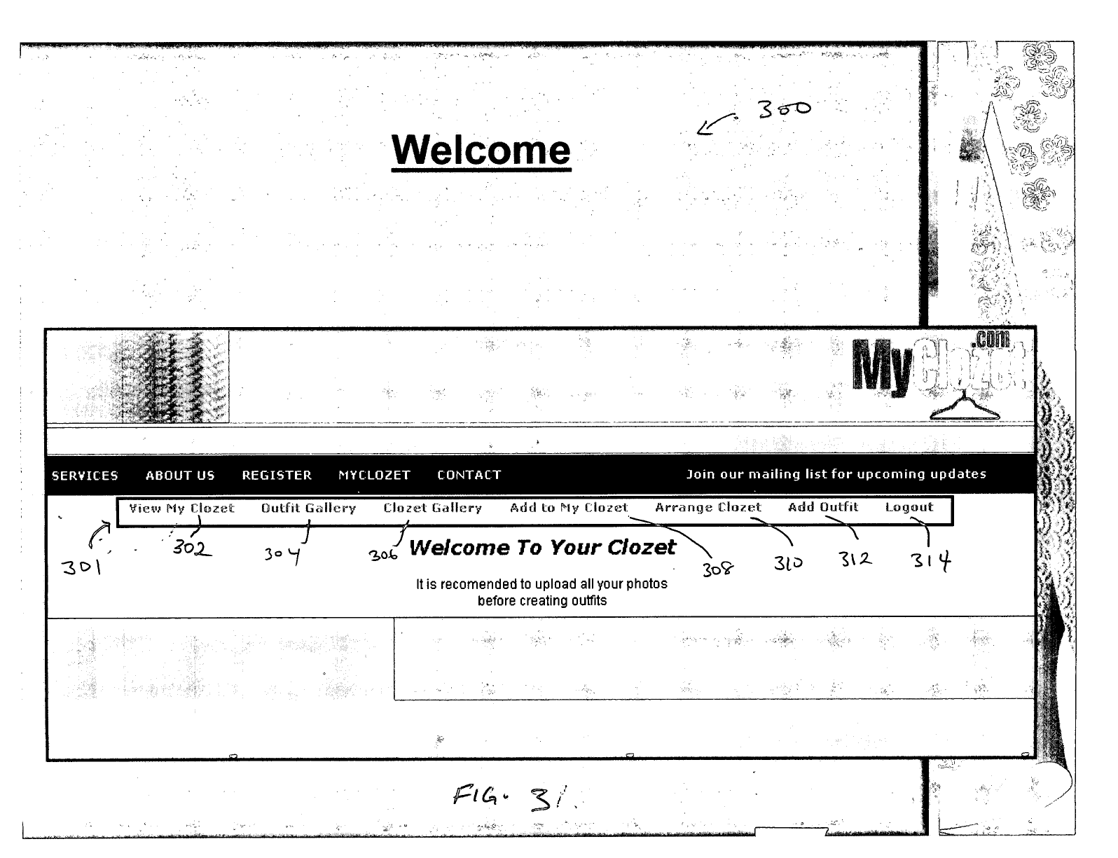

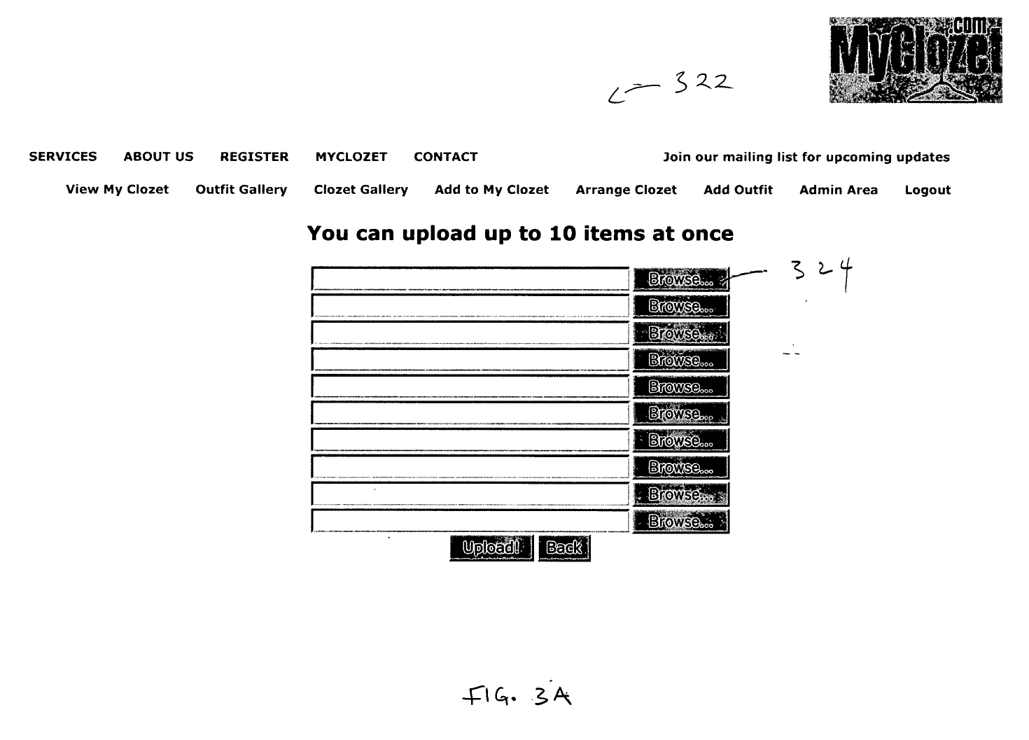

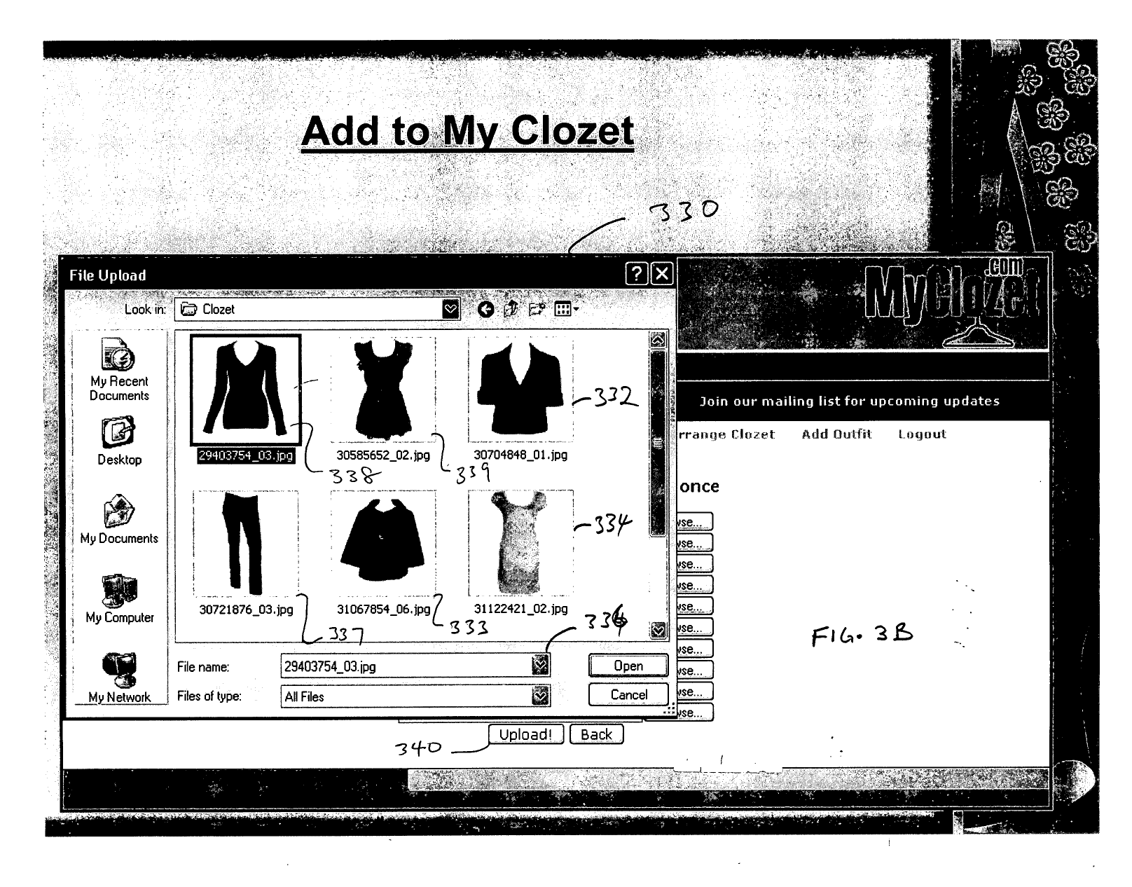

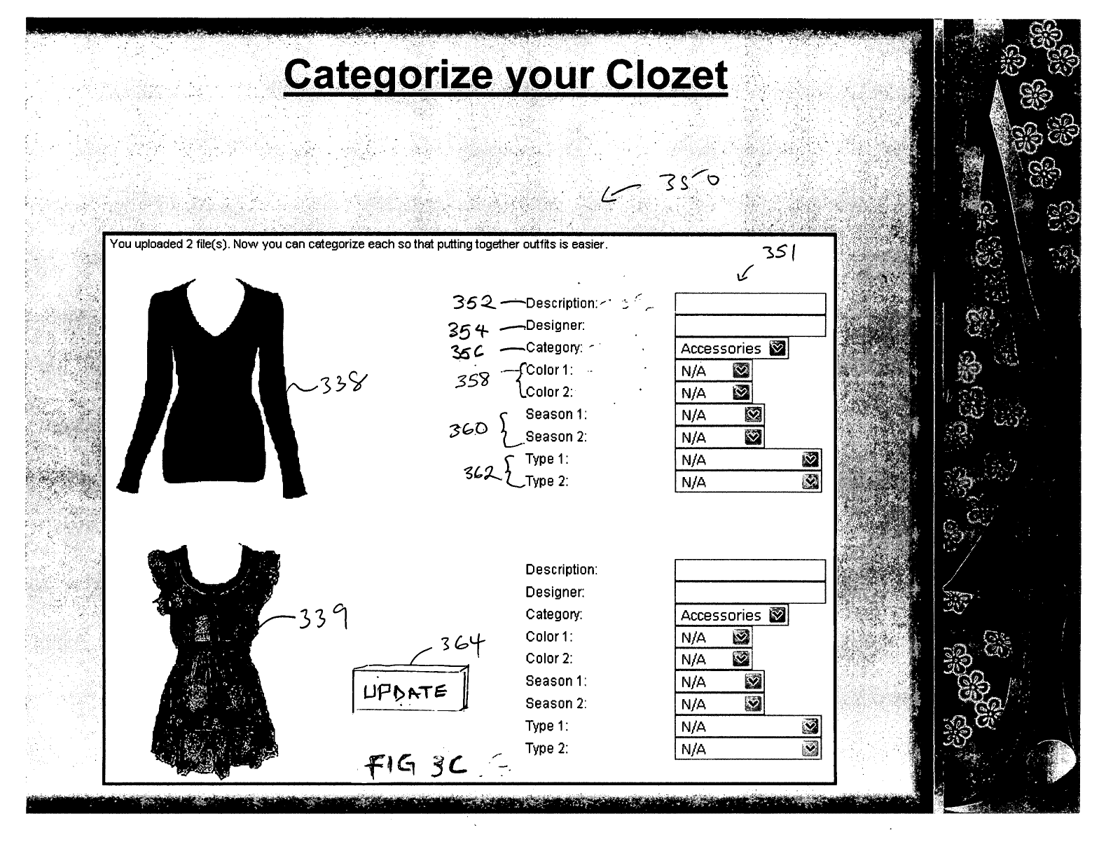

At step 214, method 200 involves receiving captured images of clothing items and accessories 800 in closet 106. Particularly, closet server system 112 is used to receive the captured images after user 104 uploads them. User 104 utilizes Internet 108 for uploading and initiates the process by logging onto www.myclozet.com. After log in, user 104 is directed to “Welcome” web page 300, a screen shot of which is illustrated in FIG. 3.

FIG. 3 shows “Welcome” page 300 according to an exemplary embodiment of the present invention.

In FIG. 3, “Welcome” page 300 is the initial web page displayed to user 104 at “www.myclozet.com.” As shown, “Welcome” page 300 includes closet navigation bar 301, which comprises selectable links for performing various functionalities. Closet navigation bar 301 includes “Add to My Clozet” 308 link that enables user 104 to initiate image uploading to closet server system 112 and “View My Clozet” 302 that allows user 104 to select predefined clothing outfits by using a drop-down menu.

Other selectable links are “Outfit Gallery” 304, which permits user 104 to display every outfit stored in the closet while “Clozet Gallery” 306 displays images and corresponding image name. “Arrange Clozet” 310 is for arranging images in the closet (e.g. searching, edit, etc.). “Add Outfit” 312 allows user 104 to group images into outfits while “Logout” 314 logs user 104 out the system. As noted, when selected by user 104, “Add to My Closet” 308 initiates the image upload process by displaying upload web page 322.

FIG. 3A shows upload page 322 according to an exemplary embodiment of the present invention.

In FIG. 3A, upload page 322 permits user 104 to upload captured images of clothing items and accessories. Specifically, up to 10 captured images can be uploaded simultaneously. Upload page 322 includes browse buttons 324, any of which can be utilized to search for captured images on the computer system. Upon selection of browse button 324, dialog box 330 of FIG. 3B is displayed.

FIG. 3B shows “File Upload” dialog box 330 in accordance with an exemplary embodiment of the present invention.

In FIG. 3B, user 104 might use dialog box 330 for selecting captured images of clothing items and accessories to be uploaded. As shown, JPEG images 338, 339, 332, 337, 333 and 334 can be selected for uploading. User 104 can select images either by using drop-down menu 336 or clicking on the displayed images themselves. Note that these JPEG images are corresponding images of clothing items and accessories 800 of FIG. 8. So, for example, shirt image 338 (FIG. 3B) is the corresponding image of clothing item 808 (FIG. 8). After selecting the desired images, user 104 then clicks “Upload” button 340 to initiate image transfer. After completion of the upload process, “Categorize Your Clozet” web page 350 of FIG. 3C is displayed.

At step 216 (FIG. 2), after image uploading, method 200 involves categorizing or classifying the captured images according to attributes or characteristics of the clothing items and accessories. This step is further illustrated by a screen shot of “Categorize Your Clozet” web page 350 of FIG. 3C.

FIG. 3C shows “Categorize Your Clozet” page 350 according to an exemplary embodiment of the present invention.

In FIG. 3C, after uploading, user 104 can immediately begin to employ page 350 to categorize uploaded images. User 104 categorizes each image based on one or more clothing attributes or characteristics. As shown, shirt image 338 and blouse image 339 have been uploaded. User 104 begins to categorize shirt image 338 starting with “Description” field 352, which allows the user to enter text descriptions of the corresponding clothing item. In this case, the description for shirt image 338 might be: “Shirt Purchased at Bloomingdale's 2004 ½ Year Sale.” Next, user 104 continues categorizing by entering the appropriate designer name in the “Designer” field 354. User 104 could enter “Versace,” for example. Next, the appropriate category is selected from “Category” 356 drop-down menu. Here, user 104 can select from: “Accessories,” “Skirt,” “Hat,” “Shirt,” “Pants,” “Dress,” “Jacket” and “Shoes,” without limitation. Here, the appropriate selection for shirt image 338 is “Shirt.”

User 104 now uses Color 358 drop-down menu for color selection. Specifically, user 104 selects “Black” for shirt image 338. Other selectable colors are “Red,” “Blue,” “Green,” “Yellow,” “Purple,” “Pink,” “Grey,” “White” “Beige,” are available without limitation. Next, user 104 employs Seasons 360 drop-down menu to categorize shirt image 338. User 104 makes the appropriate selection from: “Fall,” “Winter,” “Spring” and “Fall.” A further category is also selected from Type 362 drop-down menu. Type 362 allows user 104 to select from “Sport,” “Casual,” “Business,” “Business Casual,” “Evening,” “Semi Casual.” “N/A” can also be selected for all of the options discussed above.

After the uploaded images are categorized, user 104 simply uses “Update” button 364 to update the system using the newly entered information, and so that user 104 can begin to search, organize and perform other novel functionalities offered by the present invention. Unlike conventional closets, user 104 can employ attributes to quickly narrow choices for clothing items and accessories 800 to be worn thus saving considerable time and effort during the dress up process.

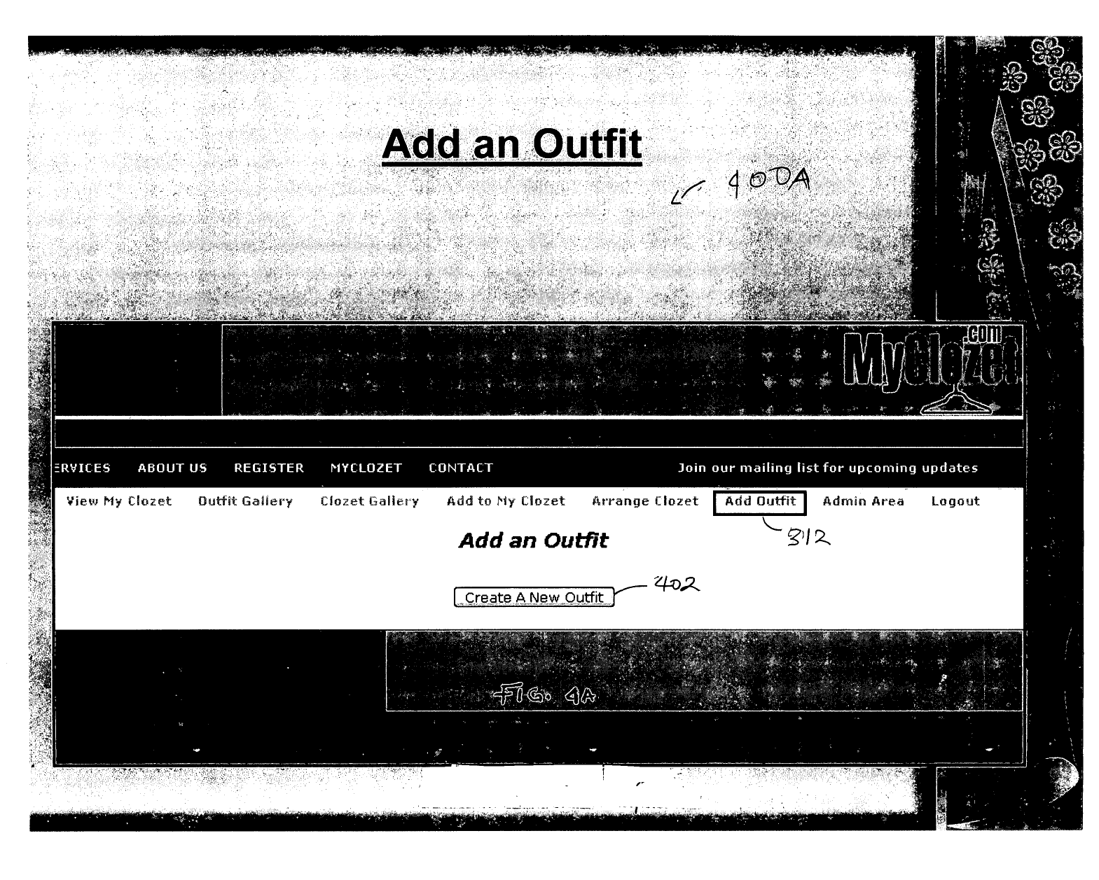

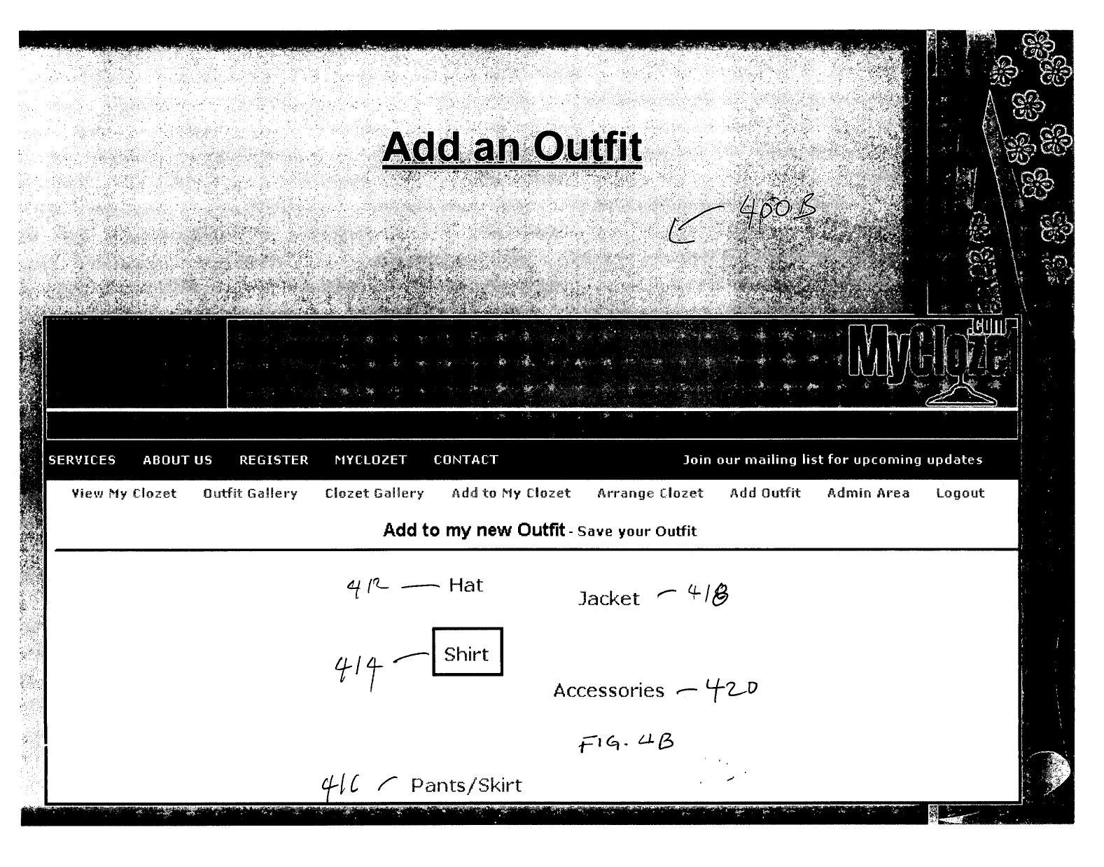

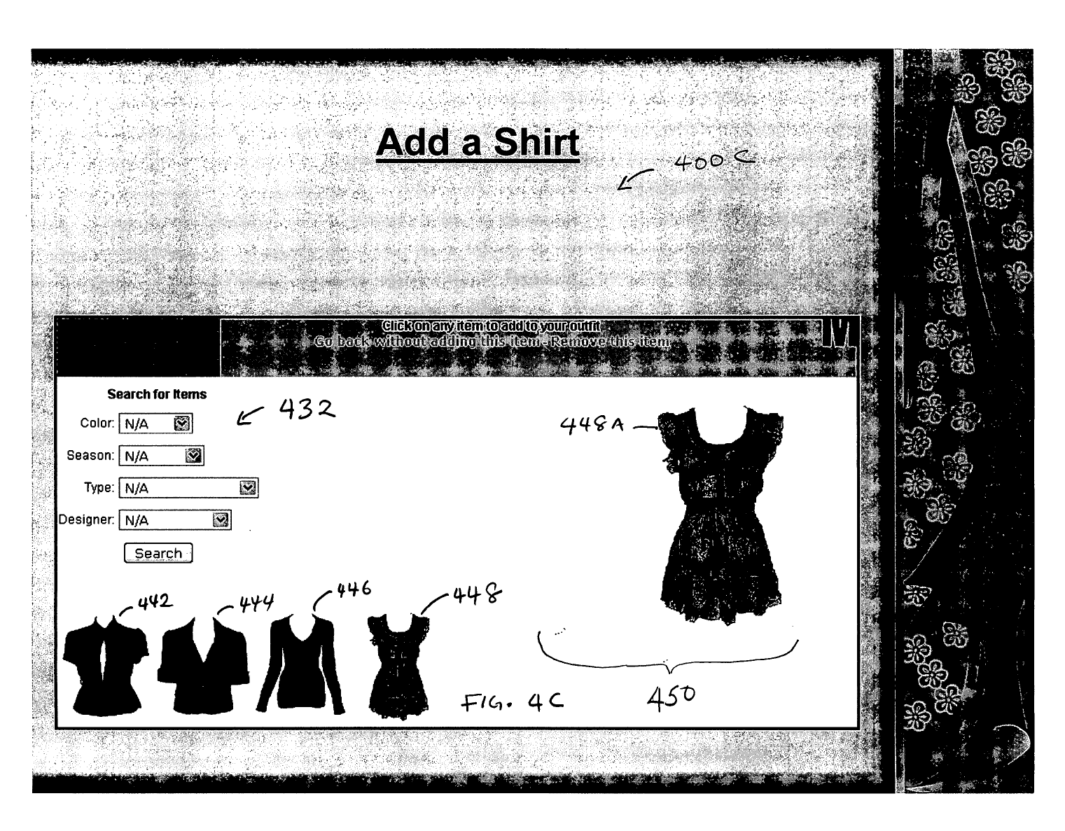

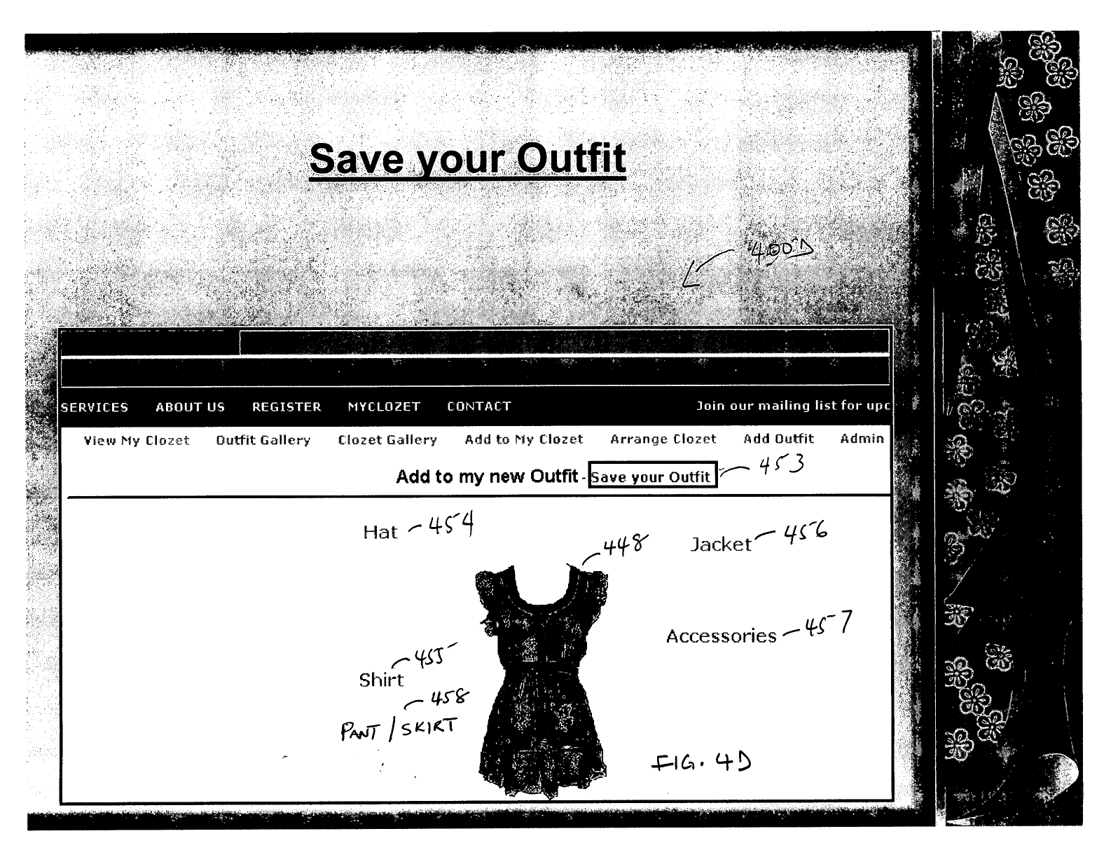

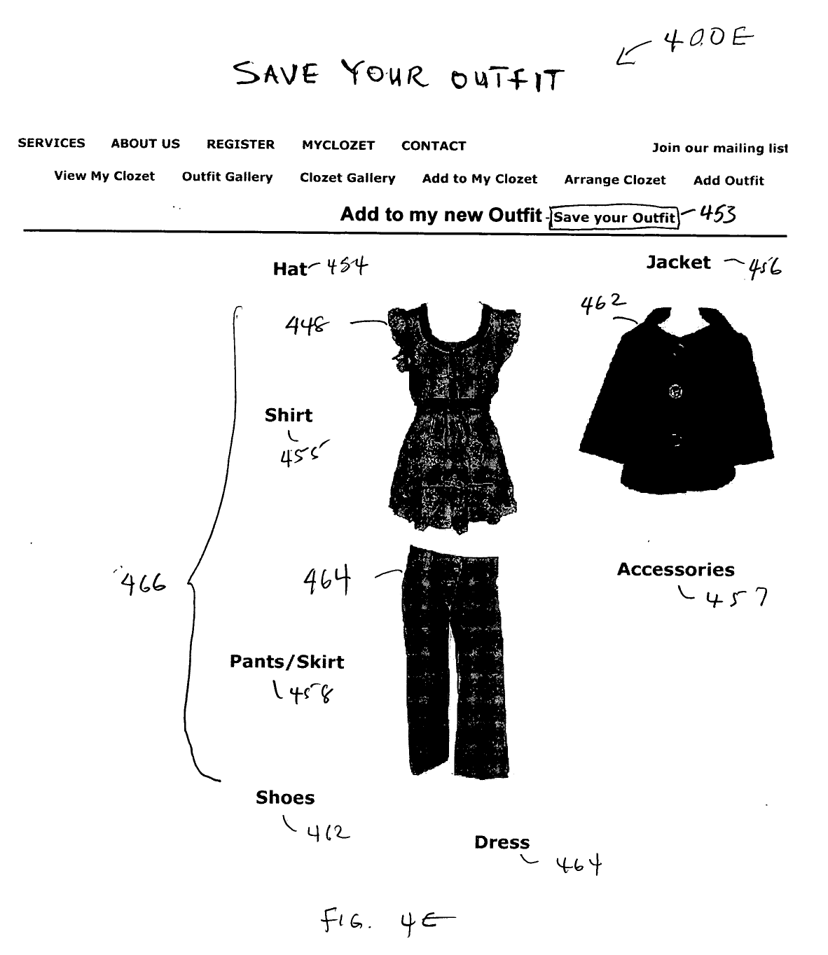

At step 218 of FIG. 2, method 200 involves grouping two or more captured images into an outfit if the captured images (or corresponding clothing items and accessories) are complementary and storing the one or more outfits for future retrieval. Note that user 104 may elect to skip this step, which is further illustrated by various screen shots described with reference to FIGS. 4A-4E, below. “Add an Outfit” web page 400A is displayed when the user clicks “Add Outfit” link 312 shown in FIG. 3.

FIG. 4A shows “Add an Outfit” page 400A according to an exemplary embodiment of the present invention.

In FIG. 4A, user 104 employs “Add an Outfit” page 400A to initiate creation of an outfit by adding one or more images. An outfit is a combination of two or more images corresponding to clothing items and accessories that match or complement each other. An outfit also provides a visually pleasant combination. As shown in FIG. 4A, user 104 simply selects the “Create A New Outfit” button 402 to initiate the outfit creation process. The system responds by displaying the “Add an Outfit” web page 400B shown in FIG. 4B.

FIG. 4B shows “Add an Outfit” page 400B according to an exemplary embodiment of the present invention.

In FIG. 4B, user 104 employs “Add an Outfit” page 400B for selecting specific clothing items and accessories for an outfit. As shown, the clothing items and accessories links available for selection are “Hat” link 412, “Shirt” link 414, “Pants/Skirt” link 416, “Jacket” link 418 and “Accessories” link 420. Here, user 104 has selected “Shirt” link 414, which generates “Add a Shirt” web page 400C of FIG. 4C.

FIG. 4C shows “Add a Shirt” web page 400C according to an exemplary embodiment of the present invention.

In FIG. 4C, “Add a Shirt” page 400C results from selecting “Shirt” link 414 of FIG. 4B. As shown, “Add a Shirt” page automatically displays all shirt images (thumbnails) stored online, and then enables user 104 to select one for an outfit. As shown, shirt image 442, shirt image 444, shirt image 446 and blouse image 448 are displayed. Here, user 104 selects blouse image 448 for an outfit. In response, an enlarged blouse image 448A is displayed in active viewing area 450. This enlarged blouse image 448A, is then selected, which has a twofold effect. First, blouse image 448 is added to the outfit, that is, it forms the initial clothing item of the outfit. Second, “Save Your Outfit” web page 400D shown in FIG. 4D is generated.

FIG. 4D shows “Save Your Outfit” page 400D in accordance with an exemplary embodiment of the present invention.

In FIG. 4D, user 104 utilizes “Save Your Outfit” page 400D for displaying and saving outfits. Specifically, FIG. 4D shows an outfit consisting of blouse image 448 (added in FIG. 4C). User 104 can also add additional clothing items and accessories to the outfit by using “Hat” link 454, “Shirt” link 455, “Pant/Shirt” link 458, “Jacket” link 456 and “Accessory” link 457. For example, to add a jacket, user 104 selects “Jacket” link 456. In response, “Add a Jacket” web page (not shown) similar to “Add a Shirt” page 400C of FIG. 4C is displayed. As in FIG. 4C, “Add a Jacket” page displays all available jackets in the closet, after which the FIG. 4C is repeated to add the selected jacket to the outfit. Similarly, to add a pant/skirt to the outfit, “Pant/Skirt” link 458 is selected, and the FIG. 4C process is repeated. As another advantage of the present invention, links 454, 455, 458, 456 and 457 are placeholders, which position a selected image near its corresponding link. For example, a jacket image when added is positioned near its corresponding link 456. When all outfit components have been added, “Save Your Outfit” page 400D now resembles “Save Your Outfit” page 400E of FIG. 4E.

FIG. 4E shows “Save Your Outfit” web page 400D according to an exemplary embodiment of the present invention.

In FIG. 4E, newly added outfit 466 is shown. User 104 now uses “Save Your Outfit” page 400D to store outfit 466. Specifically, user 104 selects “save your outfit” link 453 for saving outfit 466, which is then saved under a name selected by user 104. Thus, outfit 466 might be named “Corporate Casual” for example. Further yet, note that additional clothing items and accessories may be added by using the shown clothing and accessory links. For example, a hat and a pair of shoes can be added by using “Hat” link 454 and “Shoes” link 462, respectively. After outfit 466 is saved, it is added to outfit gallery wherein all saved outfits can be viewed.

Hereinbefore, descriptions referencing FIGS. 4A-4E have provided a novel and unique aspect never before disclosed in conventional closet systems. The present invention enables user 104 to predefine and store outfits in advance of dress up. For example, user 104 prior to returning home from work and in anticipation of a gala event that evening can simply access closet server system 112 and browse all predefined outfits and determine in advance which outfit is suitable for the gala event. The conventional process of attempting to determine outfits during dress up is herein and forever eliminated thus saving users considerable energy and time.

Referring back to FIG. 2, at step 220, method 200 involves storing said captured images for future retrieval by a user. Specifically, closet server system 112 having received all captured images (and outfits if added) can now store all captured images. In this manner, user 104 can access and manage these captured images in the future. Method 200 of FIG. 2 is thus concluded.

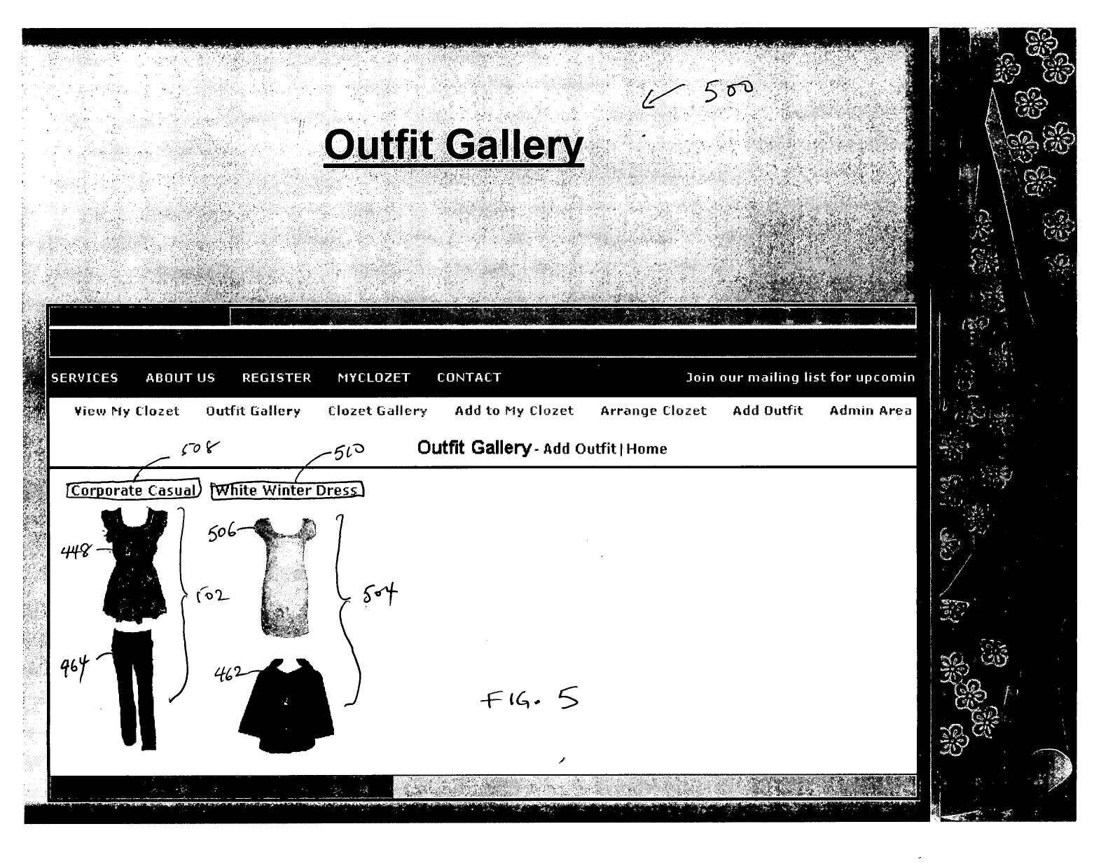

Referring now to FIGS. 5-7, screens shots illustrating methods and systems for managing previously captured images will now be described.

FIG. 5 shows “Outfit Gallery” web page 500 according to an exemplary embodiment of the present invention.

In FIG. 5, user 104 employs this web page for displaying all previously created outfits in closet 106. “Outfit Gallery” page 500 is itself accessed by selecting “Outfit Gallery” link 304 of the homepage shown in FIG. 3. As shown, two exemplary outfits are currently displayed. “Corporate Casual” outfit 502 comprises blouse 448 and Pants 464 while “White Winter Dress” 504 consists of Dress 506 and Jacket 462. Outfits may be edited or modified by selecting the appropriate link. “Corporate Casual” link 508 modifies that outfit and “White Winter Dress” link 510 edits its corresponding outfit. In this manner, flexibility is retained to modify outfits as proves necessary.

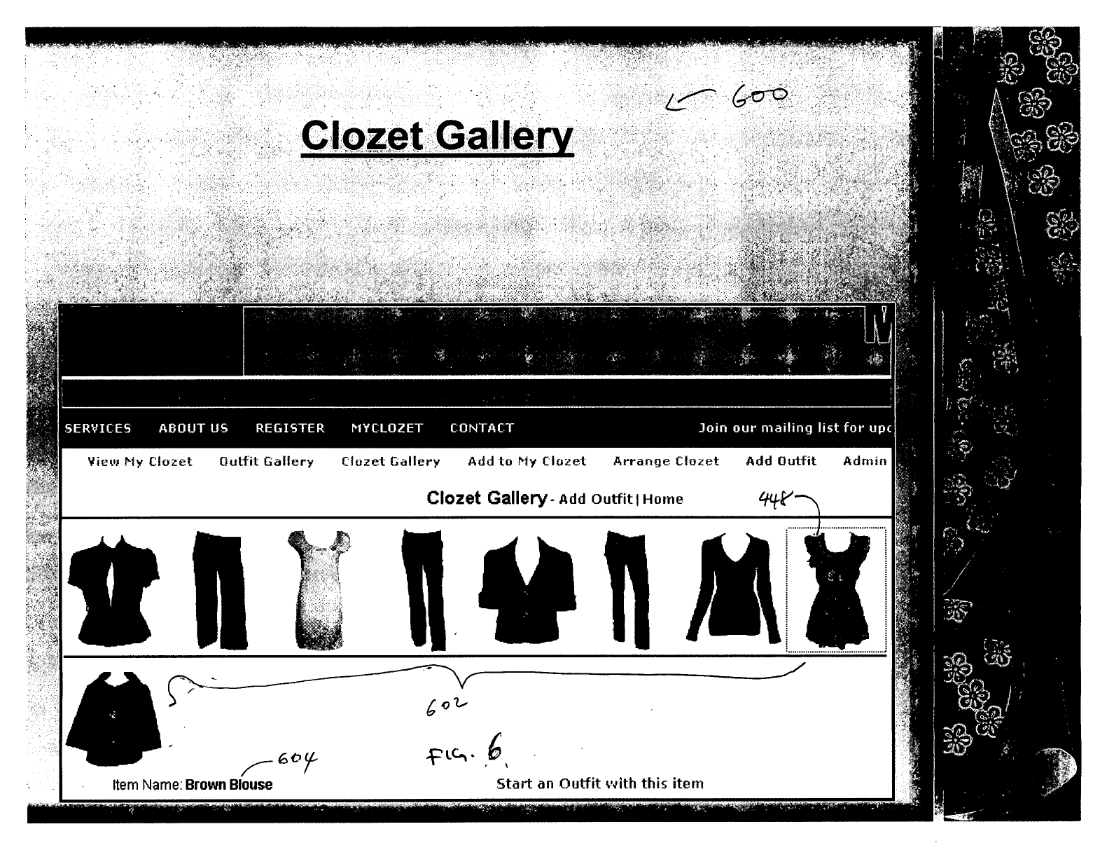

FIG. 6 shows “Clozet Gallery” web page 600 according to an exemplary embodiment of the present invention.

In FIG. 6, “Clozet Gallery” page 600 allows user 104 to view all clothing items and accessories (and their corresponding names) in closet 106. “Clozet Gallery” page 600 is itself accessed by selecting “Outfit Gallery” link 306 of the homepage shown in FIG. 3. As shown, all clothing items and accessories 602 stored in closet 106 are displayed. When a particular image is selected, its corresponding name is also displayed. Thus, as shown, user 104 has selected blouse 448 and its name “Brown Blouse” 604 is displayed. In this manner, the present invention, unlike conventional closet systems, can display full front views and track all clothing items and accessories images irrespective of whether a closet is crowded or whether clothing item edges remain visible.

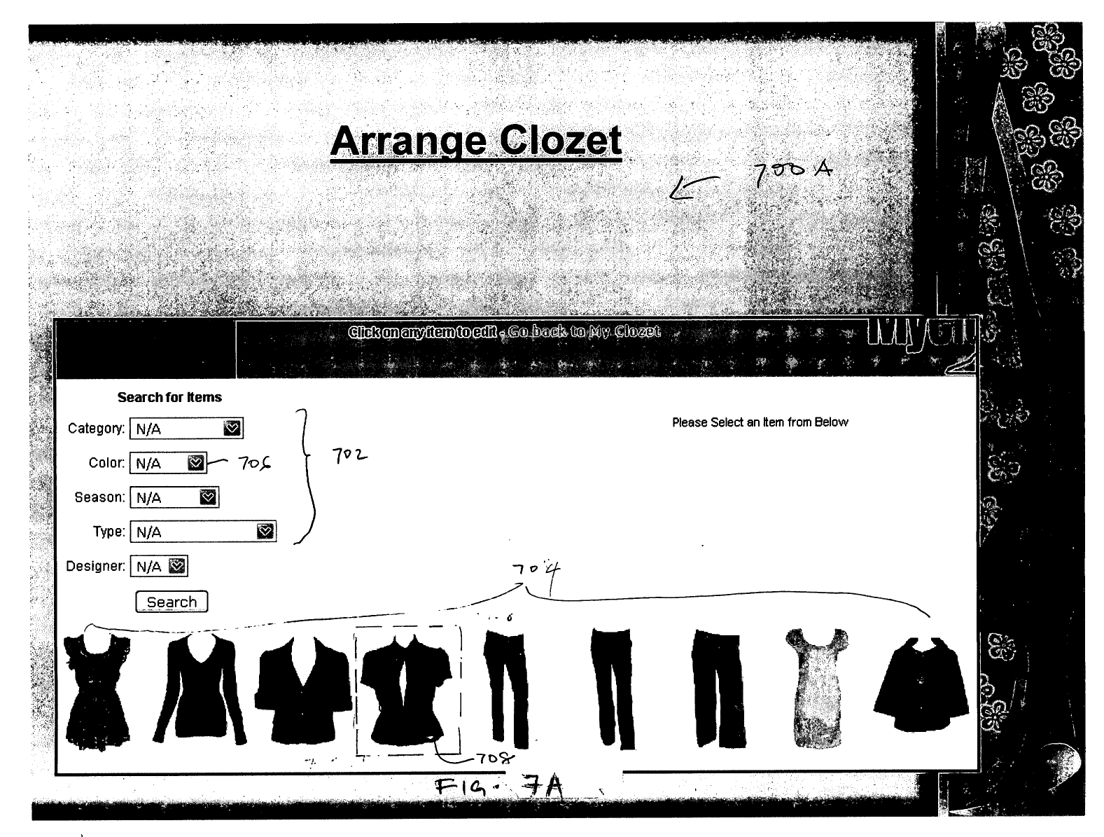

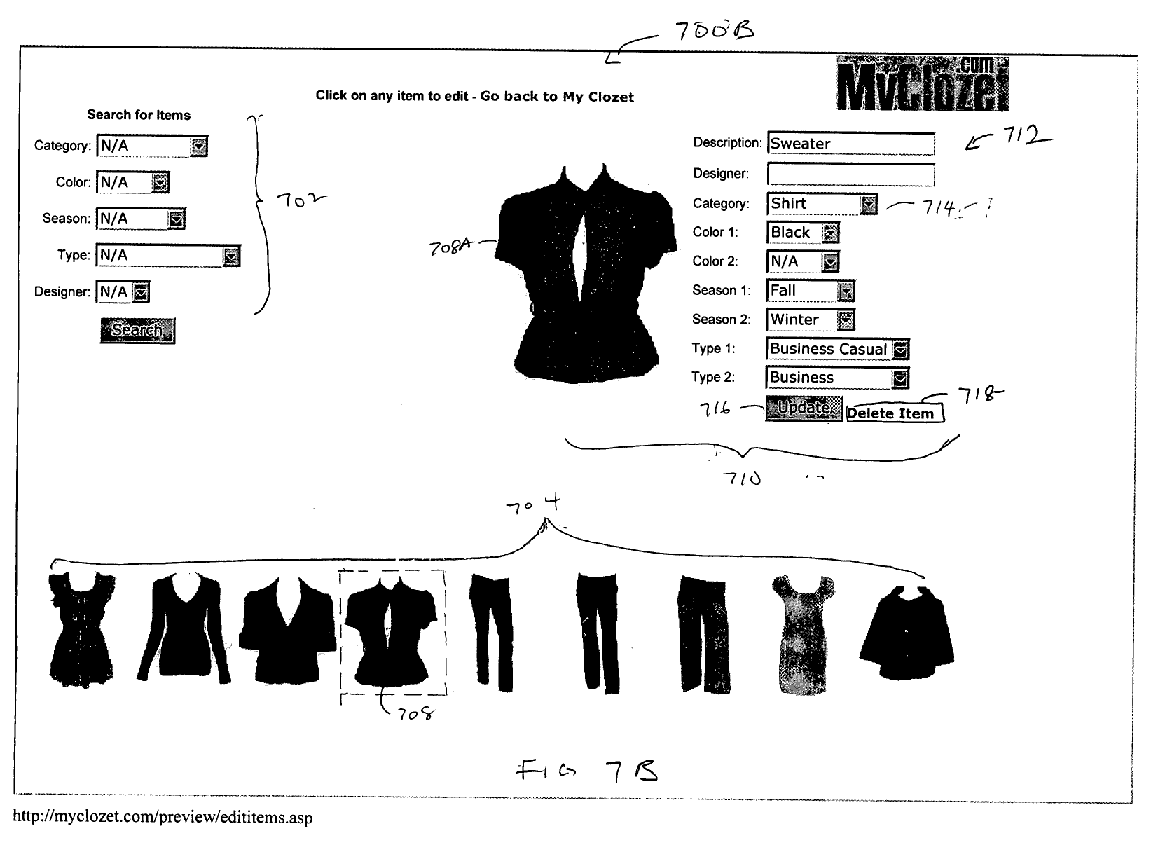

FIG. 7A shows “Arrange Clozet” web page 700A according to an exemplary embodiment of the present invention.

In FIG. 7A, user 104 can utilize this web page for modifying clothing items and accessories in closet 106. “Arrange Clozet” page 700A is itself accessed by selecting “Arrange Clozet” link 310 of the homepage shown in FIG. 3. As shown, all clothing items and accessories 704 stored in closet 106 are displayed. In conjunction, “Search for Items” drop-down menus 702 are shown for narrowing displayed images to selected criteria. For example, when “Black” is selected for “Color” drop-down menu 706, only black clothing items and accessories 704 are displayed. Additionally, as shown, user 104 having selected Sweater 708 causes the display of “Arrange Clozet” web page 700B of FIG. 7B.

FIG. 7B shows “Arrange Clozet” page 700B in accordance with an exemplary embodiment of the present invention.

In FIG. 7B, user 104 uses “Arrange Clozet” page 700B to select one of the clothing items and accessories displayed by “Arrange Clozet” page 700A of FIG. A. As shown, user 104 having selected Sweater 708 generates enlarged sweater image 708A and drop-down menus 712 in active viewing area 710. This allows user 104 to use drop-down menus 712 to modify descriptions and categories for Sweater 708. For example, as shown by “Category” drop-down menu 714, Sweater 708 is categorized as “Shirt.” User 104 may select a different category by using drop-down menu 714 and thereafter select “Update” button 716 to store the change. In fact, user 104 might choose to delete this item. In that case, “Delete Item” button 718 is selected for this purpose.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A system for using images to manage clothing items and accessories in a closet, the system comprising:
an imaging device capable of capturing images of the clothing items and accessories;
an online server; and
a computing device that receives said captured images from the imaging device and uploads said captured images to the online server,
wherein upon user request, the online server categorizes said captured images according to one or more attributes of the clothing items and accessories, and
wherein upon user request, the online server stores said captured images for future retrieval according to the one or more attributes of the clothing items and accessories.

2. The system of claim 1 wherein upon user request the online server groups two or more of said captured images into an outfit if said two or more captured images are complementary.

3. A method for organizing clothing items and accessories in a closet, the method comprising:
capturing images of the clothing items and accessories;
uploading said captured images to a remote location;
categorizing said captured images by using one or more characteristics of the clothing items and accessories; and
storing said captured images for future retrieval according to the one or more characteristics of the clothing items and accessories.

4. The method of claim 3 further comprising grouping two or more captured images into an outfit based on whether said captured images are matching.

5. A method for managing a user's personal closet, the method comprising:
(a) receiving captured images of clothing items and accessories in the closet;
(b) classifying said captured images according to attributes of the clothing items and accessories; and
(c) storing said captured images for future retrieval by a user.

6. The method of claim 5 wherein each of (a), (b) and (c) is implemented by an online server.

7. The method of claim 5 further comprising:
grouping two or more captured images into an outfit if said images are complementary; and
storing the one or more outfits for future retrieval.

8. The method of claim 5 further comprising:
receiving a user request for access to said captured images;
authenticating the user request for access to said captured images, and
if so, providing user access to said captured images for searching, viewing or arranging said captured images.

9. The method of claim 5 wherein the captured images received in (a) are from a digital camera.

10. The method of claim 9 wherein the captured images received in (a) are captured by the user of the closet.

11. The method of claim 9 wherein the captured images received in (a) are captured by a distributor or seller of clothing items and accessories.

12. The method of claim 5 wherein the attributes are selected from any one or more of type, color, season, category, designer and description.

13. The method of claim 7 wherein an outfit is selected from any two or more captured images of a hat, jacket, shirt, pants or skirt, sweater and accessories.

14. The method of claim 5 further comprising searching the captured images based on one or more attributes selected from type, color, season, category, designer and description.

15. The method of claim 7 further comprising displaying all stored outfits for viewing upon user request.

16. The method of claim 5 further comprising displaying all images stored in (c) upon user request.

17. A system for organizing clothing items and accessories in a closet, the system comprising:
means for capturing images of the clothing items and accessories in the closet;
means for uploading said captured images;
means for categorizing said captured images by using one or more characteristics of the clothing items and accessories, and
means for storing said captured images for future retrieval by a user.

18. The system of claim 15 further comprising means for grouping two or more captured images into an outfit based on whether said images are matching.

19. The system of claim 15 further comprising means for searching the captured images based on one or more attributes selected from type, color, season, category, designer and description.

20. The method of claim 3 further comprising:
receiving a request for access to the captured images;
authenticating the request for access; and
if the request is valid, searching said captured images based on the request for access according to the one or more characteristics of the clothing items and accessories.
